(19) United States
(12) Patent Application Publication
(10) Pub. No.: US 2015/0156640 A1
(43) Pub. Date: Jun. 4, 2015

(54) POSITION CALCULATION METHOD, COMPUTER PROGRAM PRODUCT, AND POSITION CALCULATION DEVICE

(71) Applicant: Kabushiki Kaisha Toshiba, Minato-ku (JP)

(72) Inventors: Cam Iy NGUYEN, Yokohama (JP); Hiroyuki Kitagawa, Yokohama (JP); Tatsuma Hirano, Chiyoda (JP); Ren Sakata, Yokohama (JP)

(73) Assignee: Kabushiki Kaisha Toshiba, Minato-ku (JP)

(21) Appl. No.: 14/557,849

(22) Filed: Dec. 2, 2014

(30) Foreign Application Priority Data
Dec. 3, 2013 (JP) 2013-250481

(51) Int. Cl. H04W 16/18; H04W 64/00; H04W 24/02

(52) U.S. Cl. CPC H04W 16/18; H04W 24/02; H04W 64/003

(57) ABSTRACT

According to an embodiment, a position calculation method includes obtaining a plurality of candidate positions each of which represents a position of a corresponding one of a plurality of base stations to be installed in a wireless network; calculating a condition of an optimization problem for deciding installation positions of base stations from the candidate positions by using probabilities of connection between a plurality of terminals included in the wireless network and the base stations installed at the candidate positions; and calculating the installation positions by solving the optimization problem under the condition.

### CROSS-REFERENCE TO RELATED APPLICATION

This application is based upon and claims the benefit of priority from Japanese Patent Application No. 2013-250481, filed on Dec. 3, 2013; the entire contents of which are incorporated herein by reference.

### FIELD

Embodiments described herein relate generally to a position calculation method, a computer program product, and a position calculation device.

### BACKGROUND

In regard to a wireless network in which a plurality of wireless terminals is present; a method is known by which, while installing base stations that are capable of wirelessly communicating with all wireless terminals, the number of base station is minimized. According to this method, if the positions of a plurality of wireless terminals are provided along with candidate positions at which the base stations can be installed; then it becomes possible to install the least number of base stations without having to install the base stations at all candidate positions and enable each wireless terminal to communicate with one of the base stations.

However, in the actual wireless communication, due to the fading or collision of signals in the wireless transmission channels, the probability of connection between a base station and a wireless terminal is expressed as a value in the range of 0 to 1. However, conventionally, the least number of base stations is obtained under the assumption that the probability of connection between a base station and a wireless terminal is either 0 or 1. For that reason, in the conventional method, the least number of base stations may be calculated to be a greater number than the least number of base stations in the actual wireless communication.

### BRIEF DESCRIPTION OF THE DRAWINGS

FIG. 1 is a diagram for explaining a network system applicable to each embodiment;

FIG. 2 is a functional block diagram illustrating the functions of a position calculation device that is applicable to a first embodiment;

FIG. 3 is a flowchart for explaining an example of a position calculation process according to the first embodiment;

FIG. 4 is a diagram illustrating an example for installing a base station according to the first embodiment;

FIG. 5 is a diagram illustrating an example for installing base station are decided according to the first embodiment;

FIG. 6 is a block diagram illustrating an exemplary configuration that enables implementation of the position calculation device according to each embodiment; and

FIG. 7 is a block diagram illustrating another exemplary configuration of a position calculation system applicable to each embodiment.

### DETAILED DESCRIPTION

According to an embodiment, a position calculation method includes obtaining a plurality of candidate positions each of which represents a position of a corresponding one of a plurality of base stations to be installed in a wireless network; calculating a condition of an optimization problem for deciding installation positions of base stations from the candidate positions by using probabilities of connection between a plurality of terminals included in the wireless network and the base stations installed at the candidate positions; and calculating the installation positions by solving the optimization problem under the condition.

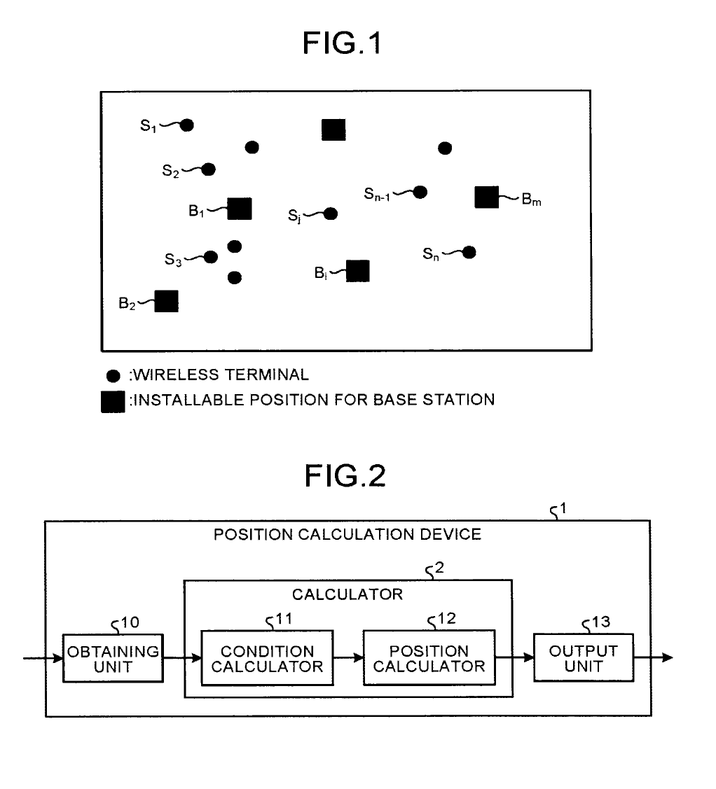

Described below are exemplary embodiments of a position calculation method, a computer program product, and a position calculation device. Firstly, prior to the explanation of the embodiments, the explanation is given with reference to FIG. 1 about a rough outline of a network configuration applicable to all embodiments.

With reference to FIG. 1, a network system applicable to all embodiments includes one or more wireless terminals S₁, S₂, . . . , Sⱼ, . . . , Sₙ₋₁, and Sₙ illustrated as black circles; and includes base stations that are installed at selected candidate positions from among candidate positions B₁, B₂, . . . , Bᵢ, . . . , Bₘ illustrated as black quadrangles.

In the following explanation, the wireless terminals S₁, S₂, . . . , Sⱼ, . . . , Sₙ₋₁, and Sₙ are representatively written as a wireless terminal Sⱼ. In an identical manner, the candidate positions B₁, B₂, . . . , Bᵢ, . . . , Bₘ for installing base stations are representatively written as a candidate position Bᵢ.

Herein, the wireless terminal Sⱼ is, for example, a wireless device, a wireless sensor node, or a wireless terminal of a user of wireless technology. Moreover, the wireless terminal Sⱼ is configured to be able to communicate with a base station via another wireless terminal. A base station is, for example, a wireless access point or a concentrator.

In the embodiments, from among the candidate positions B₁, B₂, . . . , Bᵢ, . . . , Bₘ, the determination of the candidate positions at which base stations are to be installed is done based on the probability of connection between each wireless terminal Sⱼ and the base station to be installed at each candidate position Bᵢ. Herein, the probability of connection is a value in the range from 0 to 1. The closer the probability of connection to 0, the more difficult it becomes to establish connection. In contrast, the closer the probability of connection to 1, the easier it is to establish connection.

Meanwhile, in the following explanation, “the probability of connection between each wireless terminal Sⱼ and the base station to be installed at each candidate position Bᵢ” is written as “the probability of connection between each wireless terminal Sⱼ and each base station” assuming an installed base station at each candidate position Bᵢ.

### First Embodiment

The following explanation is given about a position calculation method according to a first embodiment for calculating the position of a base station. According to the first embodiment, in a network system, the installation position of each base station is calculated in such a way that the probability of connection between each wireless terminal Sⱼ and a base station is equal to or greater than a certain probability. FIG. 2 is a functional block diagram illustrating the functions of a position calculation device 1 that is applicable to the first embodiment. With reference to FIG. 2, the position calculation device 1 includes a calculator 2, an obtaining unit 10, and an output unit 13.

The obtaining unit 10 obtains a variety of data required by the calculator 2 in calculating the position of a base station. The calculator 2 further includes a condition calculator 11 and a position calculator 12. Based on the variety of data obtained by the obtaining unit 10, the calculator 2 calculates position information that indicates the candidate position Bᵢ, from among preset candidate positions Bᵢ for installing base stations, at which the concerned base station is to be installed. The output unit 13 outputs the position information calculated by the calculator 2.

In the position calculation device 1, the calculator 2 and the obtaining unit 10 are implemented using a position calculation program that runs in a central processing unit (CPU). However, that is not the only possible case. Alternatively, the calculator 2 as well as the obtaining unit 10 can be configured using dedicated hardware. Moreover, the position calculation program that implements the calculator 2 and the obtaining unit 10 may also implement some of the functions of the output unit 13.

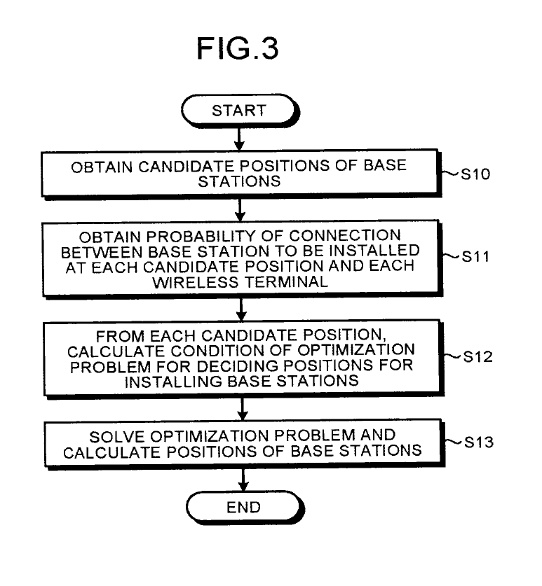

FIG. 3 is a flowchart for explaining an example of a position calculation process according to the first embodiment. The position calculation device 1 performs the position calculation process, which is explained with reference to the flowchart illustrated in FIG. 3, and calculates the installation positions of the base stations in a network system. In the position calculation device 1, the obtaining unit 10 obtains each candidate position Bᵢ for installing a base station (Step S10). Then, the obtaining unit 10 obtains the probability of connection between each wireless terminal Sⱼ and the base station to be installed at each candidate position Bᵢ obtained at Step S10 (Step S11).

Subsequently, the condition calculator 11 calculates, from each candidate position Bᵢ, the condition of an optimization problem for determining the positions at which the base stations are to be installed (Step S12). According to the first embodiment, the condition calculator 11 calculates the condition of an optimization problem in which the probability of connection obtained, at Step S11, between each wireless terminal Sⱼ and the base station to be installed at each candidate position Bᵢ is equal to or greater than a certain probability. In other words, at Step S12, subject to the condition that the probability of connection between each wireless terminal Sⱼ and the base station to be installed at each candidate position Bᵢ is equal to or greater than a certain probability, the condition calculator 11 converts the method of determining the base station positions from each candidate position Bᵢ into an optimization problem.

Then, the position calculator 12 solves the optimization problem under the condition obtained at Step S12, and calculates the positions for installing the base stations from among the candidate positions Bᵢ (Step S13).

Given below is a more detailed explanation of the processes performed at each step of the flowchart illustrated in FIG. 3. At Step S10 performed at the start, the obtaining unit 10 obtains the candidate positions for installing a base station. Conventionally, regarding the determination of the candidate positions for installing the base station, various methods have been proposed.

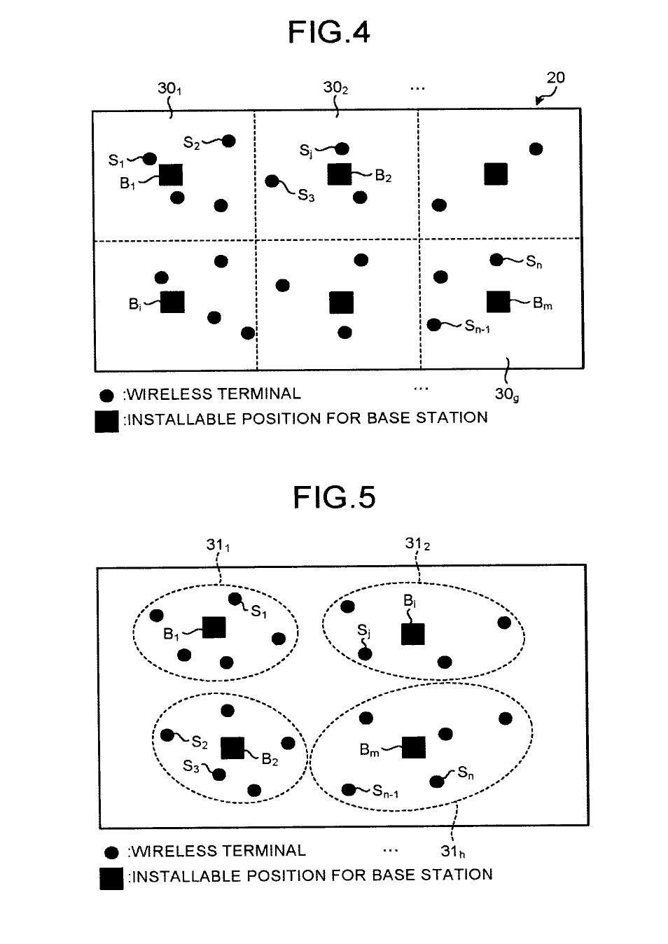

In FIG. 4 is illustrated an example in which an area is partitioned into predetermined grids, and the central position of each grid is treated as the candidate position Bᵢ for installing a base station. For example, to the obtaining unit 10, the user inputs information of an area 20 in which the wireless terminals Sⱼ are disposed and inputs the number of grids into which the area 20 is divided. Based on the input information, the obtaining unit 10 partitions the area 20 into small areas 30₁, 30₂, . . . , 30_{g} according to the predetermined grids. Then, the obtaining unit 10 obtains the central position of each small area 30₁, 30₂, . . . , 30_{g} and obtains the central position of each small area as the candidate position Bᵢ for installing a base station.

In FIG. 5 is illustrated an example according to the first embodiment in which the installed wireless terminals Sⱼ are grouped and, based on the positions of the wireless terminals Sⱼ in each group, the candidate positions Bᵢ for installing base stations are decided. For example, the user inputs the position information of each wireless terminal Sⱼ to the obtaining unit 10. Then, based on each set of position information that is input; the obtaining unit 10 obtains groups 31₁, 31₂, . . . , 31ₕ to which the wireless terminals Sⱼ belong. However, that is not the only possible case. Alternatively, the user can specify, to the obtaining unit 10, the groups 31₁, 31₂, . . . , 31ₕ to which the wireless terminals Sⱼ belong.

Based on the installation positions of the wireless terminals Sⱼ that belong to the groups 31₁, 31₂, . . . , 31ₕ; the obtaining unit 10 obtains the candidate position Bᵢ for installing a base station in each of the groups 31₁, 31₂, . . . , 31ₕ. For example, with respect to each of the groups 31₁, 31₂, . . . , 31ₕ; the obtaining unit finds the center of gravity of the position of the wireless terminal Sⱼ and obtains the centers of gravity as the candidate positions Bᵢ for installing base stations in the groups 31₁, 31₂, . . . , 31ₕ.

Meanwhile, the method of obtaining the candidate positions Bᵢ for installing base stations is not limited to the method described above. That is, the obtaining unit 10 can obtain the candidate positions Bᵢ using any other method. For example, depending on the status of the area in which the wireless terminals Sⱼ are installed, the user can arbitrarily select the candidate positions Bᵢ for installing base stations. For example, the user associates identification information i to each candidate position Bᵢ that has been decided, and inputs the sets of identification information i to the position calculation device 1. Then, the obtaining unit 10 of the position calculation device 1 obtains the identification information i associated to each candidate position Bᵢ that has been input.

At the subsequent Step S11, the obtaining unit 10 obtains the probability of connection which indicates the probability at which the base station to be installed at each candidate position Bᵢ, which is obtained at Step S10, is connectible to each wireless terminal Sⱼ. Herein, the obtaining unit 10 obtains the probabilities of connection assuming that a base station has been installed at each candidate position Bᵢ.

Meanwhile, in the embodiments, “m” represents the number of candidate positions Bᵢ for installing base stations and “n” represents the number of wireless terminals Sⱼ (where m and n are integers equal to or greater than one). Moreover, the candidate position for installing the i-th base station is defined as the installation candidate position Bᵢ (1≦i≦m), and the j-th wireless terminal is defined as the wireless terminal Sⱼ (1≦j≦n). Furthermore, the probability of being able to establish connection between the base station to be installed at the candidate position Bᵢ and the wireless terminal Sⱼ is defined as a probability Pᵢⱼ of connection.

In the following explanation, “the probability of connection between each wireless terminal Sⱼ and the base station to be installed at each candidate position Bᵢ” is written as “the probability Pᵢⱼ of connection between each wireless terminal Sⱼ and each base station” assuming an installed base station at each candidate position Bᵢ.

When the positions of the base stations and the positions of the wireless terminals Sⱼ are provided, it becomes possible to calculate the probability Pᵢⱼ of connection between each wireless terminal Sⱼ and each base station. Herein, the probability Pᵢⱼ of connection can be calculated by implementing a known method. For example, the probability Pᵢⱼ of connection can be calculated according to the distance between the position of the wireless terminal Sⱼ and the position of a base station (i.e., the candidate position Bᵢ). In this case, if the distance between the position of the wireless terminal Sⱼ and the position of a base station is within a predetermined range, then it is also possible to think of setting the probability Pᵢⱼ of connection to “1”.

Meanwhile, if it is possible to measure the signal-to-noise ratio (SNR) between the wireless terminal Sⱼ and a base station, then the probability Pᵢⱼ of connection can also be calculated based on the SNR. Moreover, in a fading environment, if it is possible to measure the temporal changes in the mutual information present in the communication between the wireless terminal Sⱼ and a base station, then the probability at which the mutual information within a predetermined time period is equal to or greater than a threshold value can be used as the probability Pᵢⱼ of connection.

The obtaining unit 10 obtains, for example, each probability Pᵢⱼ of connection that is input by the user and that has been calculated externally. However, that is not the only possible case. Alternatively, the obtaining unit 10 can calculate each probability Pᵢⱼ of connection based on a variety of information input by the user. Then, the obtaining unit 10 sends, to the condition calculator 11, the probability Pᵢⱼ of connection obtained, at Step S11, between each wireless terminal Sⱼ and the base station to be installed at each candidate position Bᵢ.

Then, at Step S12, the condition calculator 11 calculates the condition of an optimization problem for deciding, from the candidate positions Bᵢ, the installation positions of the base stations for which the probabilities Pᵢⱼ of connection sent from the obtaining unit 10 are equal to or greater than a predetermined threshold value. Firstly, using the probability Pᵢⱼ of connection, a logarithmic value Qᵢⱼ is defined according to Equation (1) given below. Herein, using an exponential exp( ), Equation (1) can be expressed as Equation (2) given below. The logarithmic value Qᵢⱼ obtained using Equation (1) represents a logarithmic value of the probability of not being able to establish connection between a single wireless terminal Sⱼ and the base station to be installed at a single candidate position Bᵢ.

Qᵢⱼ=log(1−Pᵢⱼ) (1)

1−Pᵢⱼ=exp(Qᵢⱼ) (2)

Given below is a more detailed explanation of the method of calculating the condition of the optimization problem at Step S12. In the first embodiment, in order to ensure network connectivity, the installation positions of the base stations are decided in such a way that the number of base stations is the smallest under the condition that the probability Pᵢⱼ of connection between each wireless terminal Sⱼ and the base station at each candidate position Bᵢ is equal to or greater than a threshold value Pₜₕ (0<Pₜₕ≦1).

Herein, the threshold value Pₜₕ can be decided, for example, based on the probability of a single successful communication in the network system within a predetermined time period. Alternatively, for example, the threshold value Pₜₕ can be decided based on the probability of a single successful communication during a predetermined period in a predetermined communication cycle. However, the method of deciding the threshold value Pₜₕ is not limited to these examples.

Moreover, a value bᵢ is defined to be equal to “1” when the candidate position Bᵢ for installing a base station is selected as the installation position of a base station, and is defined to be equal to “0” when the candidate position Bᵢ is not selected. Using the value bᵢ, the number of base stations to be installed can be expressed in Expression (3) given below.

$${\sum }_{1 \leq i \leq m} {b}_{i} \qquad ( 3 )$$

Firstly, the explanation is given about the method of calculating the probability at which a single wireless terminal Sⱼ is connectible to the base station corresponding to at least a single candidate position Bᵢ. The probability at which the wireless terminal Sⱼ is not connectible to any of the base stations is expressed as Expression (4) given below.

$${\prod }_{i such that {b}_{i} = 1} ( 1 - {P}_{ij} ) \qquad ( 4 )$$

Thus, using Equation (1) and Expression (4) given above, a probability Pj at which a single wireless terminal Sⱼ is connectible to the base station corresponding to at least a single candidate position Bᵢ is expressed as Equation (5) given below.

$$\begin{matrix}{P}_{j} = 1 - {\prod }_{i such that {b}_{i} = 1} ( 1 - {P}_{ij} ) \\ = 1 - {\prod }_{i such that {b}_{i} = 1} exp ( {Q}_{ij} ) \\ = 1 - exp {\sum }_{i such that {b}_{i} = 1} {Q}_{ij} \\ = 1 - exp {\sum }_{1 \leq i \leq m} {b}_{i} \cdot {Q}_{ij}\end{matrix} \qquad ( 5 )$$

Herein, from the condition that the probability Pᵢⱼ of connection between the wireless terminal Sⱼ and the base station to be installed at a single candidate position Bᵢ is equal to or greater than the threshold value Pₜₕ, it is possible to derive Inequality (6) given below.

$$\begin{matrix}{P}_{j} \geq {P}_{th} \\ ⇔ 1 - exp {\sum }_{1 \leq i \leq m} {b}_{i} \cdot {Q}_{ij} \geq {P}_{th} \\ ⇔ {\sum }_{1 \leq i \leq m} {b}_{i} \cdot {Q}_{ij} \leq log ( 1 - {P}_{th} )\end{matrix} \qquad ( 6 )$$

Meanwhile, from Equation (1) given above, Equation (7) given below holds true in regard to the threshold value Pₜₕ.

Qₜₕ=log(1−Pₜₕ) (7)

From Equation (7) and Inequality (6) given above, the value bᵢ is obtained that satisfies Expression (8) given below. With that, it becomes possible to obtain the least number of base stations, that is, the least number of candidate positions to be selected from among all candidate positions Bᵢ.

$$Min {\sum }_{1 \leq i \leq m} {b}_{i} \\ s . t . ∀ j , {\sum }_{1 \leq i \leq m} {b}_{i} \cdot {Q}_{ij} \leq {Q}_{th} \\ ∀ i , {b}_{i} ∈ \{ 0 , 1 \} \qquad ( 8 )$$

In Expression (8), for all wireless terminals S₁, S₂, . . . , Sⱼ, . . . , Sₙ included in the network system and for all combinations in which one or more base stations are selected from among the base stations to be installed at all candidate positions B₁, B₂, . . . , Bᵢ, . . . , Bₘ; the probability of not being able to establish connection between the wireless terminal Sⱼ and the base station to be installed at the candidate position Bᵢ is compared with the threshold value Qₜₕ. Then, a condition is set for the optimization problem of obtaining, from among the combinations for which the probability is equal to or smaller than the threshold value Qₜₕ, the combination having the least number of base stations (the least number of candidate positions Bᵢ).

Given below is the explanation of a method implemented at Step S13 for calculating the installation positions of the base stations. Herein, at Step S13, the position calculator 12 calculates the positions of base stations from Expression (8) obtained at Step S12. That is, at Step S13, the position calculator 12 calculates the candidate positions Bᵢ having the value bᵢ equal to “1” in Expression (8).

The problem of calculating the candidate positions Bᵢ at Step S13 is a problem of mixed integer programming, and the solution of that problem can be obtained by implementing a known method of mixed integer programming. For example, the problem at Step S13 can be solved by implementing the solution method described in T. J. Van Roy, L. A. Wolsey, “Solving mixed integer programming problems using automatic reformulation,” Operations Research, January/February 1987, vol. 35, no. 1, 45-57. The solution method for the problem at Step S13 according to the first embodiment is not limited to the solution method by T. J. Van Roy et al.; and any other solution method related to mixed integer programming can be implemented.

In this way, at Step S13, the position calculator 12 calculates the required number of base stations as a value expressed using Expression (3). Moreover, the position calculator 12 outputs the candidate positions Bᵢ corresponding to the value bᵢ=1 as the installation positions of the base stations.

The information output from the position calculator 12 and indicating the number of base stations and the installation positions of the base stations is sent to the output unit 13 and, for example, is displayed on a display unit (not illustrated). However, that is not the only possible case. Alternatively, the output unit 13 can output the information indicating the number of base stations and the installation positions of the base stations to the outside of the position calculation device 1.

As described above, in the first embodiment, under the condition that the positions of the wireless terminals are provided, the candidate positions for installing base stations are provided, and the probability of connection between each wireless terminal and the base station to be installed at each candidate position is provided; it is possible to obtain the number of base stations and the installation positions which satisfy the condition that the probability of connection of communication between a wireless terminal and a base station is equal to or greater than a threshold value.

### Second Embodiment

Given below is the explanation of a second embodiment. Herein, in the second embodiment, when a number BSnum of the base stations to be installed is provided, the installation positions of the base stations are obtained in such a way that the minimum value of the probability of connection Pⱼ, at which each wireless terminal Sⱼ is connectible to at least a single base station, is maximized. Meanwhile, in the second embodiment, the configuration of the position calculation device 1 explained with reference to FIG. 2 according to the first embodiment is applicable without modification. Hence, the explanation of the configuration is not repeated.

The processes according to the second embodiment are explained with reference to the flowchart illustrated in FIG. 3. Herein, it is assumed that, before the processes illustrated in the flowchart are performed, the obtaining unit 10 obtains in advance, as a user input, the number BSnum of base stations to be installed.

The processes performed at Step S10 and Step S11 are same as the processes according to the first embodiment. That is, at Step S10, the obtaining unit 10 of the position calculation device 1 obtains the candidate positions Bᵢ for installing base stations. Then, at Step S11, the obtaining unit 10 obtains the probability Pᵢⱼ of connection between each wireless terminal Sⱼ and the base station to be installed at each candidate position Bᵢ obtained at Step S10.

Subsequently, at Step S12, as described above, under the condition of the number BSnum of base stations that is provided; the condition calculator 11 calculates, from the candidate positions Bᵢ, the condition of an optimization problem for deciding the positions at which the base stations are to be installed. In the second embodiment, the condition calculator 11 maximizes the minimum value of the probability Pⱼ of connection at which each wireless terminal Sⱼ is connectible to at least a single base station. The maximization of the minimum value of the probability Pⱼ of connection is synonymous to the minimization of Expression (9) given below, which is the left-hand side of Inequality (6) given above.

$${\sum }_{1 \leq i \leq m} {b}_{i} \cdot {Q}_{ij} \qquad ( 9 )$$

Thus, the maximization of the minimum value of the probability Pⱼ of connection can be expressed using Expression (10) given below.

$$Min ( {Max}_{1 \leq j \leq n} ( {\sum }_{1 \leq i \leq m} {b}_{i} \cdot {Q}_{ij} ) ) \qquad ( 10 )$$

As a result, under the condition of the number BSnum of base stations, the condition calculator 11 calculates the condition of an optimization problem of maximizing the minimum value of the probability Pⱼ of connection between each wireless terminal Sⱼ and a base station.

$$Min ( {Max}_{1 \leq j \leq n} ( {\sum }_{1 \leq i \leq m} {b}_{i} \cdot {Q}_{ij} ) ) \\ s . t . {\sum }_{i} {b}_{i} = BSnum \\ ∀ i , {b}_{i} ∈ \{ 0 , 1 \} \qquad ( 11 )$$

In Expression (11), for all wireless terminals S₁, S₂, . . . , Sⱼ, . . . , Sₙ included in the network system and for all combinations in which the base stations equal in number to the given number BSnum are selected from among the base stations to be installed at all candidate positions B₁, B₂, . . . , Bᵢ, . . . , Bₘ; the probability of not being able to establish connection between the wireless terminal Sⱼ and the base station to be installed at the candidate position Bᵢ is obtained. Then, a condition is set for the optimization problem of obtaining the combination in which the greatest probability from among all obtained probabilities is minimized.

Expression (11) can be modified as Expression (12) given below.

$$Min c \\ s . t . ∀ j , {\sum }_{1 \leq i \leq m} {b}_{i} \cdot {Q}_{ij} \leq c \\ {\sum }_{i} {b}_{i} = BSnum \\ ∀ i , {b}_{i} ∈ \{ 0 , 1 \} \qquad ( 12 )$$

At Step S13 performed subsequently, the position calculator 12 solves Expression (12) and calculates the positions of the base stations. That is, at Step S13, the position calculator 12 calculates the candidate positions Bᵢ having the value bᵢ equal to “1” in Expression (11). This problem is a problem of mixed integer programming, and the solution thereof can be obtained by implementing a known method of mixed integer programming. For example, the problem can be solved by implementing the solution method by T. J. Van Roy et al. Of course, the solution method for the problem at Step S13 according to the second embodiment is not limited to the solution method by T. J. Van Roy et al., and any other solution method related to mixed integer programming can be implemented.

In this way, at Step S13, the position calculator 12 calculates the required number of base stations as a value expressed using Expression (3). Moreover, the position calculator 12 outputs the candidate positions Bᵢ corresponding to the value bᵢ=1 as the installation positions of the base stations.

The information output from the position calculator 12 and indicating the number of base stations and the installation positions of the base stations is sent to the output unit 13 and, for example, is displayed on a display unit (not illustrated). However, that is not the only possible case. Alternatively, the output unit 13 can output the information indicating the number of base stations and the installation positions of the base stations to the outside of the position calculation device 1.

As described above, according to the second embodiment, when the number of base stations is provided, such installation positions of the base stations are obtained at which the minimum value of the probability of connection between each wireless terminal and each base station is maximized, that is, the probability of connection between a wireless terminal and a base station having difficulty in establishing connection is maximized.

Hardware configuration applicable to all embodiments

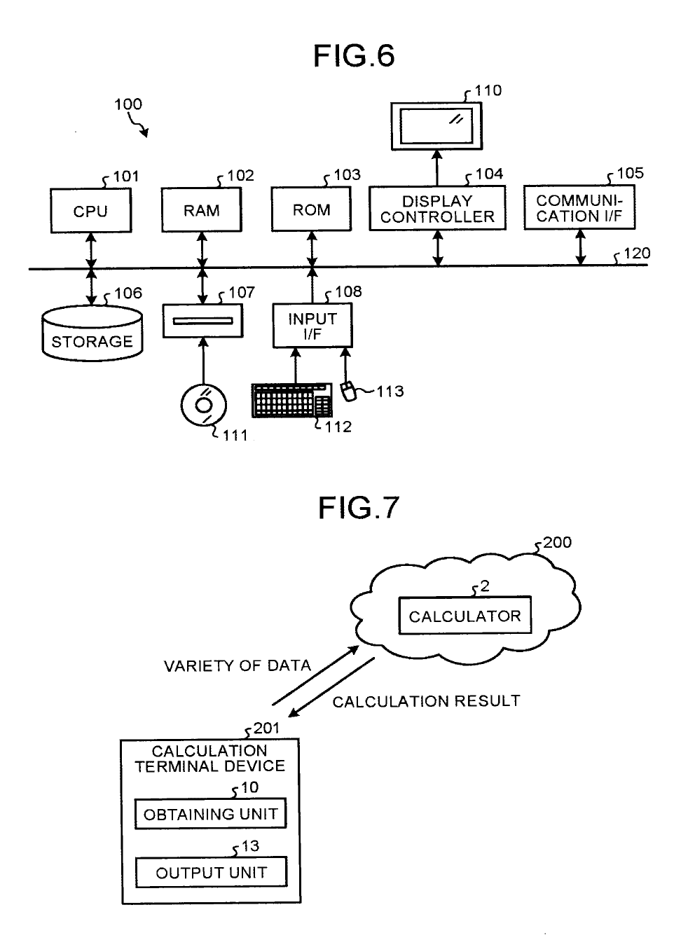

Explained below with reference to FIG. 6 is a configuration that enables implementation of the position calculation device 1 according to all embodiments. As illustrated in FIG. 6, the position calculation device 1 can be implemented using, for example, a general-purpose computer device 100.

With reference to FIG. 6, a central processing unit (CPU) 101, a random access memory (RAM) 102, a read only memory (ROM) 103, a display controller 104, and a communication interface (I/F) 105 are connected to a bus 120. In addition, a storage 106, a drive device 107, and an input I/F 108 are also connected to the bus 120.

The CPU 101 follows computer programs stored in the ROM 103 or the storage 106; uses the RAM 102 as a work area; and performs the overall control of the computer device 100. The display controller 104 converts display control signals, which are generated by the CPU 101, into signals that are displayable on a display device 110; and then outputs the converted signals.

The storage 106 is, for example, a nonvolatile semiconductor memory or a hard disk drive; and is used in storing the computer programs to be executed by the CPU 101 and the data used by the computer programs. In the drive device 107, a storage medium 111 can be inserted in a removable manner. The drive device 107 can perform data reading from at least the storage medium 111. Examples of the storage medium 111 compatible to the drive device 107 include a disk recording medium such as a compact disk (CD), a digital versatile disk (DVD), or a flexible disk; or include a readable-writable nonvolatile semiconductor memory.

The input I/F 108 receives input of data from outside. The input I/F 108 has a predetermined interface such as a universal serial bus (USB) or an IEEE 1394 interface (IEEE stands for Institute of Electrical and Electronics Engineers). Thus, the input I/F 108 receives input of data from an external device via that interface. Moreover, to the input I/F 108, input devices such as a keyboard 112 and a mouse 113 are connected. For example, according to the display on the display device 110, the user can operate the input devices to issue instructions to the computer device 100.

The communication I/F 105 performs communication with an external communication network using a predetermined protocol.

In the position calculation device 1; the obtaining unit 10, the condition calculator 11, and the position calculator 12 are implemented using a position calculation program running in the CPU 101. Herein, the position calculation program may be used to implement the output unit 13 too. The variety of information obtained by the obtaining unit 10 is, for example, created in another computer and stored therein in a file. Then, the information is stored in the storage medium 111 and provided to the computer device 100. However, that is not the only possible case. Alternatively, the obtaining unit 10 can obtain the variety of information that has been provided to the computer device 100 from outside via a network.

The position calculation program executed for performing the processes of the position calculation device 1 according to the embodiments is, for example, stored as an installable or an executable file in the computer-readable storage medium 111 such as a CD, a flexible disk, or a DVD, as a computer program product. However, that is not the only possible case. Alternatively, the position calculation program can be stored in advance in the ROM 103 and provided to the computer device 100.

Alternatively, the position calculation program can be saved as a downloadable file on a computer connected to a network such as the Internet or a local area network (LAN), and can be provided to the computer device 100 from that computer. Still alternatively, the position calculation program can be made available for distribution through a network such as the Internet.

For example, the position calculation program according to the embodiments contains modules for the obtaining unit 10, the condition calculator 11, and the position calculator 12. As far as the actual hardware is concerned, the CPU 101 reads the position calculation program from, for example, the storage 106 and executes it so that each constituent element is loaded in the RAM 102. As a result, the obtaining unit 10, the condition calculator 11, and the position calculator 12 are generated in the RAM 102.

Another example of hardware configuration applicable to all embodiments

Given below is the explanation of another example of the hardware configuration applicable to all embodiments. In FIG. 7 is illustrated another exemplary configuration of a position calculation system applicable to the embodiments. In this another example, the calculator 2 (the condition calculator 11 and the position calculator 12) according to the embodiments is configured on a network/cloud. With reference to FIG. 7, the constituent elements identical to the constituent elements illustrated in FIG. 2 are referred to by the same reference numerals, and the detailed explanation thereof is not repeated.

With reference to FIG. 7, in the position calculation system, the calculator 2 is configured on a network/cloud 200, which includes a plurality of computers interconnected via a network and which represents a network group having the interior portion thereof concealed from outside thereby functioning as a black box with only input and output presented to the outside. As far as the communication protocol in the network/cloud 200 is concerned, the TCP/IP (which stands for Transmission Control Protocol/Internet Protocol) is used, for example.

A calculation terminal device 201 includes a communication I/F for communicating with the network/cloud 200, and includes the obtaining unit 10 and the output unit 13. The obtaining unit 10 is configured in the network/cloud 200, and the calculation terminal device 201 can include an input unit that receives input of information. The calculation terminal device 201 can be, for example, a general-purpose computer device; while a dedicated device can be used as the calculator 2. As described above, the obtaining unit 10 obtains the candidate positions Bᵢ for installing base stations and obtains the probabilities Pᵢⱼ of connection between the wireless terminals Sⱼ and the candidate positions Bᵢ. The output unit 13 outputs the information indicating the installation positions of the base stations that is sent from the network/cloud 200 as well as outputs the number of base stations that is sent from the network/cloud 200.

The calculation terminal device 201 sends the variety of information obtained by the obtaining unit 10 to the network/cloud 200. Then, in the network/cloud 200, the variety of information received from the calculation terminal device 201 is sent to the calculator 2 (the condition calculator 11). Then, based on the variety of information that is received, the calculator 2 of the network/cloud 200 calculates the condition of the optimization problem for deciding the installation positions of the base stations from the candidate positions Bᵢ. Subsequently, according to the calculated condition, the calculator 2 solves the optimization problem using mixed integer programming, and calculates the installation positions of the base stations and the number of base stations. The information regarding the calculated installation positions of the base stations and the number of base stations is then sent from the network/cloud 200 to the calculation terminal device 201. Lastly, the calculation terminal device 201 outputs the information regarding the installation positions of the base stations and the number of base stations that is received from the network/cloud 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A position calculation method comprising:
obtaining a plurality of candidate positions each of which represents a position of a corresponding one of a plurality of base stations to be installed in a wireless network;
calculating a condition of an optimization problem for deciding installation positions of base stations from the candidate positions by using probabilities of connection between a plurality of terminals included in the wireless network and the base stations installed at the candidate positions; and
calculating the installation positions by solving the optimization problem under the condition.

2. The method according to claim 1, wherein the condition represents a condition in which each of the plurality of terminals has a probability of connection equal to or greater than a threshold value and in which the number of base stations included in the wireless network is minimized.

3. The method according to claim 2, wherein the condition represents a condition in which, among all possible combinations of the base stations, a probability of not being able to establish connection between the respective base stations in each combination and each of the terminals is compared with a threshold value and in which, from among the combinations each having the probability equal to or smaller than the threshold value, a combination having the least number of base stations is obtained.

4. The method according to claim 1, wherein the condition represents a condition in which, when the number of base stations included in the wireless network is provided, a minimum value of the probability of connection of each of the plurality of terminals is maximized.

5. The method according to claim 4, wherein the condition represents a condition in which, among all possible combinations of the base stations of the provided number, a probability of not being able to establish connection between the respective base stations in each combination and each of the terminals is obtained, and in which a combination in which a largest probability from among all of the obtained probabilities is minimized is obtained.

6. The method according to claim 1, wherein the obtaining includes obtaining the candidate positions of the base stations from grids into which an area of installation of the plurality of terminals is divided.

7. The method according to claim 6, wherein the obtaining includes obtaining a central position of each of the grids as a candidate position.

8. The method according to claim 1, wherein the obtaining includes obtaining a candidate position of the base station in each of groups into which the plurality of terminals are grouped.

9. The method according to claim 8, wherein the obtaining includes obtaining, on a group-by-group basis, a center of gravity of positions of the terminals included in the corresponding group as the candidate position.

10. A computer program product comprising a computer-readable medium containing a program executed by a computer, the program causing the computer to execute:
obtaining a plurality of candidate positions each of which represents a position of a corresponding one of a plurality of base stations to be installed in a wireless network;
calculating a condition of an optimization problem for deciding installation positions of base stations from the candidate positions by using probabilities of connection between a plurality of terminals included in the wireless network and the base stations installed at the candidate positions; and
calculating the installation positions by solving the optimization problem under the condition.

11. A position calculation device comprising:
an obtaining unit that a plurality of candidate positions each of which represents a position of a corresponding one of a plurality of base stations to be installed in a wireless network;
a condition calculator that calculates a condition of an optimization problem for deciding installation positions of base stations from the candidate positions by using probabilities of connection between a plurality of terminals included in the wireless network and the base stations installed at the candidate positions; and
a position calculator that calculates the installation positions by solving the optimization problem under the condition.
